(19) United States
(12) Patent Application Publication
(10) Pub. No.: US 2022/0311004 A1
(43) Pub. Date: Sep. 29, 2022

(54) NEGATIVE ELECTRODE FOR LITHIUM ION SECONDARY BATTERY AND LITHIUM ION SECONDARY BATTERY

(71) Applicant: TDK CORPORATION, Tokyo (JP)

(72) Inventors: Hiroshi SASAGAWA, Tokyo (JP); Yuji YAMAMOTO, Tokyo (JP); Kazuki MATSUSHITA, Tokyo (JP); Takashi MORI, Tokyo (JP)

(73) Assignee: TDK CORPORATION, Tokyo (JP)

(21) Appl. No.: 17/699,626

(22) Filed: Mar. 21, 2022

(30) Foreign Application Priority Data
Mar. 23, 2021 (JP) 2021-048339

(51) Int. Cl. H01M 4/62; H01M 10/0525; H01M 4/134; C08F 216/06; C08F 220/12

(52) U.S. Cl. CPC H01M 4/622; H01M 10/0525; H01M 4/134; C08F 216/06; C08F 220/12; H01M 2004/027

(57) ABSTRACT

The negative electrode for a lithium ion secondary battery includes: a current collector; and a negative electrode active material layer which is in contact with at least one surface of the current collector, the negative electrode active material layer has a negative electrode active material and a binder, the negative electrode active material contains a material that can be alloyed with Li, the binder contains a predetermined copolymer, and a specific surface area of a surface of the negative electrode active material layer on a side opposite to the current collector side is 7.0 m²/g or more and 16.0 m²/g or less.

### BACKGROUND OF THE INVENTION

### Field of the Invention

The present invention relates to a negative electrode for a lithium ion secondary battery and a lithium ion secondary battery.

Priority is claimed on Japanese Patent Application No. 2021-048339 filed on Mar. 23, 2021, the content of which is incorporated herein by reference.

### Description of Related Art

Lithium ion secondary batteries are widely used as a power source for mobile devices, such as mobile phones and notebook computers, and for hybrid cars.

The capacity of a lithium ion secondary battery mainly depends on the active material of the electrode. Graphite is generally used as the negative electrode active material, but a negative electrode active material having a higher capacity is required. Therefore, silicon (Si) and silicon oxide (SiOₓ), which have a much larger theoretical capacity than the theoretical capacity (372 mAh/g) of graphite, are attracting attention.

Si and SiOₓ have an accompanying large volume expansion during charging. The conductive path of lithium ions may be disrupted by the volume expansion of the negative electrode active material. As a result, there is a problem that the cycle characteristics of the lithium ion secondary battery are deteriorated. For example, Patent Document 1 describes that, by using non-crosslinked polyacrylic acid as a binder, the strength of the negative electrode active material layer is improved and the deterioration rate of the lithium ion secondary battery is lowered.

### Patent Documents

[Patent Document 1] Japanese Patent No. 4672985

### SUMMARY OF THE INVENTION

Further improvement of cycle characteristics is required.

The present disclosure has been made in view of the above-described problems, and an object thereof is to provide a negative electrode for a lithium ion secondary battery and a lithium ion secondary battery having excellent cycle characteristics.

In order to solve the above-described problems, the following means are provided.

(1) According to a first aspect, there is provided a negative electrode for a lithium ion secondary battery including: a current collector; and a negative electrode active material layer which is in contact with at least one surface of the current collector, in which the negative electrode active material layer has a negative electrode active material and a binder, the negative electrode active material contains a material that can be alloyed with Li, the binder contains a copolymer of a unit represented by following chemical structure (1) and a unit represented by following chemical structure (2), where R is hydrogen or a methyl group and M is an alkali metal element in chemical structure (2), and a specific surface area of a surface of the negative electrode active material layer on a side opposite to the current collector side is 7.0 m²/g or more and 16.0 m²/g or less.

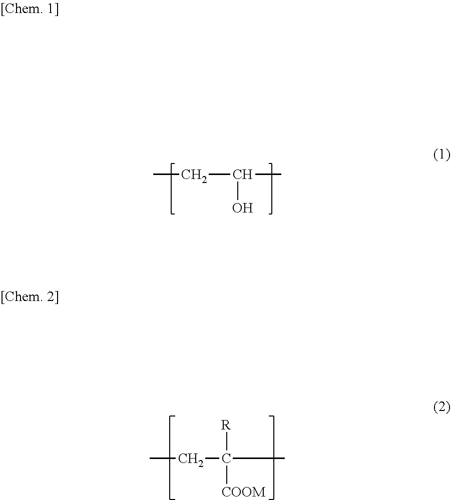

(2) In the negative electrode for a lithium ion secondary battery according to the aspect, a density of the negative electrode active material layer may be 0.4 g/cm³ or more and 1.4 g/cm³ or less.

(3) In the negative electrode for a lithium ion secondary battery according to the aspect, the negative electrode active material layer has a thickness of 10 μm or more and 50 μm or less.

(4) According to a second aspect, there is provided a lithium ion secondary battery including: the negative electrode for a lithium ion secondary battery according to the aspect.

The positive electrode for a lithium ion secondary battery and the lithium ion secondary battery according to the above-described aspect have excellent cycle characteristics.

### BRIEF DESCRIPTION OF THE DRAWINGS

FIG. 1 is a schematic view of a lithium ion secondary battery according to a first embodiment.

### DETAILED DESCRIPTION OF THE INVENTION

Hereinafter, an embodiment will be described in detail with reference to the drawings as appropriate. In the drawings used in the following description, characteristic parts are enlarged and illustrated for convenience in order to make it easy to understand the features, and the dimensional ratios of each configuration element may differ from the actual ones. In addition, the materials and dimensions exemplified in the following description are examples, the present invention is not necessarily limited thereto, and the present invention can be appropriately changed without changing the gist thereof.

### Lithium Ion Secondary Battery

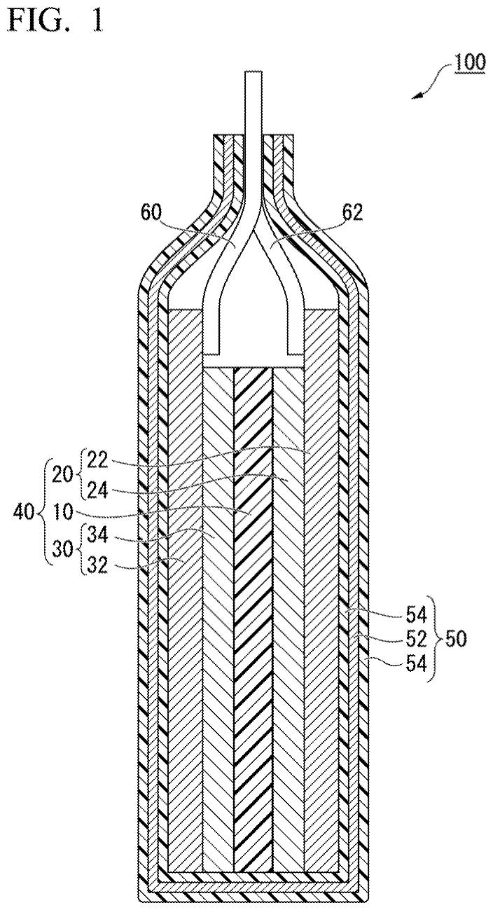

FIG. 1 is a schematic view of a lithium ion secondary battery according to a first embodiment. A lithium ion secondary battery 100 illustrated in FIG. 1 includes a power generation element 40, an exterior body 50, and a nonaqueous electrolyte (not illustrated). The exterior body 50 covers the periphery of the power generation element 40. The power generation element 40 is connected to the outside by a pair of connected terminals 60 and 62. The nonaqueous electrolyte is accommodated in the exterior body 50.

### Power Generation Element

The power generation element 40 includes a positive electrode 20, a negative electrode 30, and a separator 10.

### Positive Electrode

The positive electrode 20 has, for example, a positive electrode current collector 22 and a positive electrode active material layer 24. The positive electrode active material layer 24 is in contact with at least one surface of the positive electrode current collector 22.

### Positive Electrode Current Collector

The positive electrode current collector 22 is, for example, a conductive plate material. The positive electrode current collector 22 is, for example, a thin metal plate such as aluminum, copper, nickel, titanium, or stainless steel. The average thickness of the positive electrode current collector 22 is, for example, 10 μm or more and 30 μm or less.

### Positive Electrode Active Material Layer

The positive electrode active material layer 24 contains, for example, a positive electrode active material. The positive electrode active material layer 24 may contain a conductive auxiliary agent and a binder, if necessary.

The positive electrode active material is an electrode active material capable of reversibly carrying out the absorption and desorption of lithium ions, the elimination and insertion (intercalation) of lithium ions, or the doping and dedoping of lithium ions and counter anions.

The positive electrode active material is, for example, a composite metal oxide. Examples of the composite metal oxide include the compounds of lithium cobalt oxide (LiCoO₂), lithium nickel oxide (LiNiO₂), lithium manganese oxide (LiMnO₂), and lithium manganese spinel (LiMn₂O₄), a compound expressed by the general formula: LiNiₓCo_{y}Mn_{z}MaO₂ (in the general formula, x+y+z+a=1, 0≤x<1, 0≤y<1, 0≤z<1, 0≤a<1, where M is one or more kinds of elements selected from Al, Mg, Nb, Ti, Cu, Zn, and Cr), lithium vanadium compound (LiV₂O₅), olivine-type LiMPO₄ (where M is one or more kinds of elements selected from Co, Ni, Mn, Fe, Mg, Nb, Ti, Al, and Zr, or VO), lithium titanate (Li₄Ti₅O₁₂), and LiNiₓCo_{y}Al_{z}O₂ (0.9<x+y+z<1.1). The positive electrode active material may be an organic substance. For example, the positive electrode active material may be polyacetylene, polyaniline, polypyrrole, polythiophene, or polyacene.

Conductive auxiliary agents enhance electron conductivity between positive electrode active materials. Examples of the conductive auxiliary agent include carbon powders such as carbon black, acetylene black, and Ketjen black; carbon nanotubes; carbon materials; fine metal powders such as those of copper, nickel, stainless steel, and iron; a mixture of a carbon material and a fine metal powder; and a conductive oxide such as ITO. The conductive auxiliary agent is preferably a carbon material such as carbon black, acetylene black, or Ketjen black.

The binder binds the active material together. As the binder, a known binder can be used. The binder is, for example, a fluororesin. Examples of the fluororesin include polyvinylidene fluoride (PVDF), polytetrafluoroethylene (PTFE), tetrafluoroethylene-hexafluoropropylene copolymer (FEP), tetrafluoroethylene-perfluoroalkyl vinyl ether copolymer (PFA), ethylene-tetrafluoroethylene copolymer (ETFE), polychlorotrifluoroethylene (PCTFE), ethylene-chlorotrifluoroethylene copolymer (ECTFE), and polyvinyl fluoride (PVF).

In addition to the above, examples of the binder include vinylidene fluoride fluororubbers such as vinylidene fluoride-hexafluoropropylene fluororubber (VDF-HFP-based fluororubber), vinylidene fluoride-hexafluoropropylene-tetrafluoroethylene fluororubber (VDF-HFP-TFE-based fluororubber), vinylidene fluoride-pentafluoropropylene fluororubber (VDF-PFP-based fluororubber), vinylidene fluoride-pentafluoropropylene-tetrafluoroethylene fluororubber (VDF-PFP-TFE-based fluororubber), vinylidene fluoride-perfluoromethyl vinyl ether-tetrafluoroethylene fluororubber (VDF-PFMVE-TFE-based fluororubber), and vinylidene fluoride-chlorotrifluoroethylene fluororubber (VDF-CTFE-based fluororubber). Further, examples of the binder include cellulose, styrene/butadiene rubber, ethylene/propylene rubber, polyimide resin, polyamide-imide resin, and acrylic resin.

### Negative Electrode

The negative electrode 30 has, for example, a negative electrode current collector 32 and a negative electrode active material layer 34. The negative electrode active material layer 34 is formed on at least one surface of the negative electrode current collector 32.

### Negative Electrode Current Collector

The negative electrode current collector 32 is, for example, a conductive plate material. As the negative electrode current collector 32, the same one as the positive electrode current collector 22 can be used.

### Negative Electrode Active Material Layer

The negative electrode active material layer 34 contains a negative electrode active material and a binder. Further, if necessary, a conductive auxiliary agent may be contained.

Negative electrode active materials include materials that can be combined with lithium. Materials that can be combined with lithium are, for example, silicon, tin, germanium. Silicon, tin, and germanium may exist as an elemental substance or as a compound. The compound is, for example, an alloy, an oxide, or the like. For example, the negative electrode active material is Si or SiO₂ As an example, when the negative electrode active material is silicon, the negative electrode 30 may be called a Si negative electrode.

The negative electrode active material may be, for example, a mixture of an elemental substance or a compound of silicon, tin, or germanium and a carbon material. The carbon material is, for example, natural graphite. Further, the negative electrode active material may be, for example, an elemental substance or a compound of silicon, tin, or germanium, of which the surface is coated with carbon. The carbon material and the coated carbon enhance the conductivity between the negative electrode active material and the conductive auxiliary agent. When the negative electrode active material layer contains silicon, tin, and germanium, the capacity of the lithium ion secondary battery 100 increases.

As the conductive auxiliary agent, the same one as that of the positive electrode 20 can be used. The negative electrode active material layer 34 preferably contains, for example, a conductive auxiliary agent in an amount of 5 wt % or more and 15 wt % or less based on the total weight of the negative electrode active material layer 34.

The binder contains a copolymer of the following chemical structure (1) and the following chemical structure (2).

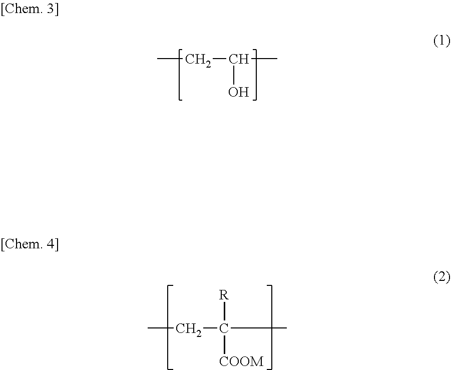

In the above-described chemical structure (2), R is hydrogen or a methyl group, and M is an alkali metal element.

The nonaqueous electrolyte has good permeability in the binder containing this copolymer. Further, the binder containing this copolymer has excellent flexibility and excellent adhesion to other layers. Therefore, in the binder containing this copolymer, even when the negative electrode active material undergoes large volume expansion during charging and discharging, elimination of the negative electrode active material from the negative electrode active material layer 34 and peeling of the negative electrode active material layer 34 from the negative electrode current collector 32 are suppressed.

This copolymer is obtained, for example, by saponifying a copolymer of a vinyl ester and at least one of an acrylic acid ester and a methacrylic acid ester. The vinyl ester is, for example, vinyl acetate, vinyl propionate, vinyl pivalate, and the like.

The unit represented by chemical structure (1) is a structure in which the unsaturated bond of vinyl alcohol is open. The unit represented by chemical structure (2) is a structure in which the unsaturated bond of (meth)acrylic acid is open. (Meth)acrylic acid is used as a general term for acrylic acid and methacrylic acid. The copolymer is a copolymerization of vinyl alcohol with an alkali metal neutralized product of (meth)acrylic acid or a (meth)acrylic acid salt.

Regarding the abundance ratio of the unit represented by chemical structure (1) and the unit represented by chemical structure (2) in the copolymer, when the total amount of these units is 100 mol %, the proportion of the units represented by chemical structure (1) is preferably 5 mol % or more, more preferably 50 mol % or more, still more preferably 60 mol % or more. The proportion of the units represented by chemical structure (1) is preferably 95 mol % or less, more preferably 90 mol % or less.

The content of this copolymer in the negative electrode active material layer 34 is, for example, 2% by mass or more, preferably 5% by mass or more. The content of this copolymer in the negative electrode active material layer 34 is, for example, 15% by mass or less, preferably 10% by mass or less.

The binder may contain other constituents other than the above-described copolymer. Examples of the other compositions include a binder used for the above-described positive electrode, cellulose, styrene/butadiene rubber, ethylene/propylene rubber, polyimide resin, polyamide-imide resin, and acrylic resin. Cellulose is, for example, carboxymethyl cellulose (CMC) or the like.

The negative electrode active material layer 34 has a first surface which is in contact with the negative electrode current collector 32 and a second surface opposite to the first surface. The specific surface area of the second surface of the negative electrode active material layer 34 is 7.0 m²/g or more and 16.0 m²/g or less. The specific surface area is a BET specific surface area obtained by using a BET method.

When the specific surface area of the second surface of the negative electrode active material layer 34 is within the above-described range, the liquid retention properties of the negative electrode active material layer 34 with respect to the nonaqueous electrolyte are improved. When a sufficient electrolyte is present on the surface of the negative electrode active material, the reaction on the surface of the negative electrode active material is homogenized, and excessive side reactions between the electrolyte and the negative electrode active material are suppressed. As a result, unnecessary reactions are reduced, excessive volume expansion of the negative electrode active material layer 34 is suppressed, and the cycle characteristics of the lithium ion secondary battery 100 are improved.

The density of the negative electrode active material layer 34 is, for example, 0.4 g/cm³ or more and 1.4 g/cm³ or less. When there is an appropriate space in the negative electrode active material layer 34, this space functions as a buffer material against the volume expansion of the negative electrode active material.

The thickness of the negative electrode active material layer 34 is, for example, 10 μm or more and 50 μm or less. When the thickness of the negative electrode active material layer 34 is large, the influence of the volume expansion of the negative electrode active material layer 34 becomes large. Since the negative electrode active material layer 34 contains the above-described copolymer and the specific surface area of the second surface is within the above-described range, even when the thickness of the negative electrode active material layer 34 is large, the cycle characteristics of the lithium ion secondary battery 100 can be maintained.

### Separator

The separator 10 is sandwiched between the positive electrode 20 and the negative electrode 30. The separator 10 isolates the positive electrode 20 and the negative electrode 30, and prevents a short circuit between the positive electrode 20 and the negative electrode 30. The separator 10 extends in-plane along the positive electrode 20 and the negative electrode 30. Lithium ions can pass through the separator 10.

The separator 10 has, for example, an electrically insulating porous structure. Examples of the separator 10 include a single layer of a film made of a polyolefin such as polyethylene or polypropylene; a stretched film of a laminate or a mixture of the above-described resins; or a fibrous nonwoven fabric made of at least one constituent material selected from the group consisting of cellulose, polyester, polyacrylonitrile, polyamide, polyethylene, and polypropylene. The separator 10 may be, for example, a solid electrolyte. The solid electrolyte is, for example, a polymer solid electrolyte, an oxide-based solid electrolyte, or a sulfide-based solid electrolyte.

### Terminal

The terminals 60 and 62 are connected to the positive electrode 20 and the negative electrode 30, respectively. The terminal 60 connected to the positive electrode 20 is a positive electrode terminal, and the terminal 62 connected to the negative electrode 30 is a negative electrode terminal. The terminals 60 and 62 are responsible for electrical connection with the outside. The terminals 60 and 62 are formed of a conductive material such as aluminum, nickel, and copper. The connection method may be welding or screwing. It is preferable to protect the terminals 60 and 62 with an insulating tape in order to prevent a short circuit.

### Exterior Body

The exterior body 50 seals the power generation element 40 and the nonaqueous electrolyte inside. The exterior body 50 suppresses leakage of the nonaqueous electrolyte to the outside and invasion of water and the like into the lithium ion secondary battery 100 from the outside.

The exterior body 50 has, for example, as illustrated in FIG. 1, a metal foil 52 and resin layers 54 laminated on each surface of the metal foil 52. The exterior body 50 is a metal laminate film in which the metal foil 52 is coated from both sides with a polymer film (resin layer 54).

As the metal foil 52, for example, an aluminum foil can be used. A polymer film such as polypropylene can be used for the resin layer 54. The materials that form the resin layer 54 may be different between the inside and the outside. For example, a polymer having a high melting point, for example, polyethylene terephthalate (PET) or polyamide (PA), is used as the outer material, and polyethylene (PE), polypropylene (PP), or the like can be used as the material of the inner polymer film.

### Nonaqueous Electrolyte

The nonaqueous electrolyte is sealed in the exterior body 50 and impregnated in the power generation element 40. The nonaqueous electrolyte has, for example, a nonaqueous solvent and an electrolyte. The electrolyte is dissolved in a nonaqueous solvent.

The nonaqueous solvent contains, for example, a cyclic carbonate and a chain carbonate. Cyclic carbonate solvates the electrolyte. Cyclic carbonates are, for example, ethylene carbonate, propylene carbonate, and butylene carbonate. The cyclic carbonate preferably contains at least propylene carbonate. The chain carbonate reduces the viscosity of the cyclic carbonate. The chain carbonate is, for example, diethyl carbonate, dimethyl carbonate, and ethyl methyl carbonate. The nonaqueous solvent may also contain methyl acetate, ethyl acetate, methyl propionate, ethyl propionate, propyl propionate, y-butyrolactone, 1,2-dimethoxyethane, 1,2-diethoxyethane, and the like.

The ratio of cyclic carbonate to chain carbonate in the nonaqueous solvent is preferably 1:9 to 1:1 in volume.

The electrolyte is, for example, a lithium salt. Examples of the electrolytes include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and LiBOB. One type of lithium salt may be used alone, or two or more types may be used in combination. From the viewpoint of the degree of ionization, the electrolyte preferably contains LiPF₆.

### Manufacturing Method of Lithium Ion Secondary Battery

The positive electrode 20 is obtained by coating at least one surface of the positive electrode current collector 22 with a paste-like positive electrode slurry (coating film) and drying the positive electrode current collector 22. The positive electrode slurry is obtained by mixing a positive electrode active material, a conductive auxiliary agent, a binder, and a solvent. Commercially available products can be used as the positive electrode current collector 22 and the positive electrode active material.

The coating method of the positive electrode slurry is not particularly limited. For example, the slit-die coating method and the doctor blade method can be used as a coating method of the positive electrode slurry.

Next, the solvent is removed from the positive electrode slurry. For example, the positive electrode current collector 22 coated with the positive electrode slurry may be dried in an atmosphere of 80° C. to 150° C. By such a procedure, the positive electrode 20 in which the positive electrode active material layer 24 is formed on the positive electrode current collector 22 is obtained.

The positive electrode on which the positive electrode active material layer 24 is formed may be pressed by a roll press device or the like, if necessary. The linear pressure of the roll press varies depending on the material used, but is adjusted such that the density of the positive electrode active material layer 24 becomes a predetermined value. The relationship between the density of the positive electrode active material layer 24 and the linear pressure is obtained by a preliminary study based on the relationship with the proportion of the material that forms the positive electrode active material layer 24.

Next, the negative electrode 30 is produced. The negative electrode 30 can be produced in the same manner as the positive electrode 20. At least one surface of the negative electrode current collector 32 is coated with a paste-like negative electrode slurry. The negative electrode slurry is a paste obtained by mixing a negative electrode active material, a binder, a conductive auxiliary agent, and a solvent. The negative electrode 30 is obtained by coating the negative electrode current collector 32 with the negative electrode slurry and drying the negative electrode current collector 32.

As the binder, a binder containing a copolymer of the unit represented by the above-described chemical structure (1) and the unit represented by the above-described chemical structure (2) is prepared in advance. This copolymer can be produced by the above-described procedure.

The specific surface area of the second surface of the negative electrode active material layer 34 can be set within a predetermined range, for example, by adjusting the amount of the conductive auxiliary agent mixed in the negative electrode slurry. When the amount of the conductive auxiliary agent contained in the negative electrode slurry increases, the specific surface area of the second surface of the negative electrode active material layer 34 tends to increase.

Further, the specific surface area of the second surface of the negative electrode active material layer 34 may be adjusted, for example, by performing a surface treatment with respect to the second surface of the negative electrode active material layer 34 after drying. The surface treatment may be, for example, a physical treatment or a chemical treatment. The physical treatment is, for example, sandblasting. The scientific treatment is, for example, etching. Etching can be performed with, for example, a mixed solution of hydrofluoric acid, nitric acid, and acetic acid, potassium hydroxide, tetramethylammonium hydroxide, or the like.

Next, the separator 10, the positive electrode 20, and the negative electrode 30 are laminated such that the separator 10 is positioned between the produced positive electrode 20 and the negative electrode 30 to produce the power generation element 40. When the power generation element 40 is a wound body, the positive electrode 20, the negative electrode 30, and the separator 10 are wound around one end side thereof as an axis.

Finally, the power generation element 40 is sealed in the exterior body 50. The nonaqueous electrolyte is injected into the exterior body 50. The nonaqueous electrolyte is impregnated into the power generation element 40 by reducing the pressure, heating, or the like after injecting the nonaqueous electrolyte. By heating or the like to seal the exterior body 50, the lithium ion secondary battery 100 can be obtained.

The lithium ion secondary battery 100 according to the first embodiment has excellent cycle characteristics. In the lithium ion secondary battery 100 according to the first embodiment, it is considered that the negative electrode active material layer 34 has high liquid retention properties, and thus unnecessary side reactions are suppressed and the volume expansion of the negative electrode active material layer 34 is suppressed. The liquid retention properties of the negative electrode active material layer 34 are improved by the fact that the negative electrode active material layer 34 contains a predetermined copolymer and that the second surface of the negative electrode active material layer 34 satisfies a predetermined specific surface area.

Above, although the embodiments of the present invention have been described in detail with reference to the drawings, the respective configurations and combinations thereof in the respective embodiments are merely examples, and additions, omissions, substitutions, and other changes of configurations are possible within the scope not departing from the gist of the present invention.

### Example

### Example 1

One surface of a copper foil having a thickness of 10 μm was coated with the negative electrode slurry. The negative electrode slurry was produced by mixing a negative electrode active material, a conductive auxiliary agent, a binder, and a solvent. Silicon was used as the negative electrode active material. Acetylene black was used as the conductive auxiliary agent. As the binder, a copolymer of the above-described chemical structure (1) and chemical structure (2) was used. The ratio of the unit represented by chemical structure (1) to the unit represented by chemical structure (2) in the copolymer was 40:60 (molar ratio). Further, in chemical structure (2), R was set to H, and M was set to Li. The mass ratio of the negative electrode active material, the conductive auxiliary agent, and the binder was 80:10:10. The support amount of the negative electrode active material on the negative electrode active material layer after drying was 2 mg/cm².

Next, the copper foil coated with the negative electrode slurry was conveyed into a drying furnace at 100° C., and the solvent was dried and removed from the negative electrode slurry. The negative electrode slurry after drying becomes a negative electrode active material layer. Then, sandblasting was performed on the surface of the negative electrode active material layer. The specific surface area of the surface of the negative electrode active material layer was 7.0 m²/g. The density of the negative electrode active material layer was 1.41 g/cm³, and the thickness of the negative electrode active material layer was 9.0 μm.

Further, one surface of an aluminum foil having a thickness of 15 μm was coated with the positive electrode slurry. The positive electrode slurry was produced by mixing a positive electrode active material, a conductive auxiliary agent, a binder, and a solvent.

LiₓCoO₂ was used as the positive electrode active material. Acetylene black was used as the conductive auxiliary agent. Polyvinylidene fluoride (PVDF) was used as the binder. The mass ratio of the positive electrode active material, the conductive auxiliary agent, and the binder was 90:5:5. The support amount of the negative electrode active material on the positive electrode active material layer after drying was 20 mg/cm². The solvent was removed from the positive electrode slurry in the drying furnace to produce a positive electrode.

### Production of Lithium Ion Secondary Battery (Full Cell) for Evaluation

The produced negative and positive electrodes were alternately laminated via a polypropylene separator having a thickness of 10 μm, and 6 negative electrodes and 5 positive electrodes were laminated to produce a laminate. Furthermore, in the negative electrode of the laminate, a nickel negative electrode lead was attached to the protruding end portion of the copper foil, which is not provided with the negative electrode active material layer. Further, in the positive electrode of the laminate, an aluminum positive electrode lead was attached to the protruding end portion of the aluminum foil, which is not provided with the positive electrode active material layer, by an ultrasonic welding machine.

Then, this laminate was inserted into the exterior body of the laminate film and heat-sealed except for one surrounding place to form a closing portion. A nonaqueous electrolyte was injected into the exterior body. The nonaqueous electrolyte was obtained by adding 1.0 M (mol/L) of LiPF₆ as a lithium salt to a solvent in which fluoroethylene carbonate (FEC) and diethyl carbonate (DEC) were mixed in a volume ratio of 1:9. Then, the remaining one place was sealed by heat-sealing while reducing the pressure with a vacuum sealer to produce a lithium ion secondary battery (full cell).

Then, the cycle characteristics of the lithium ion secondary battery were obtained. The cycle characteristics were realized using a secondary battery charge/discharge test device (manufactured by HOKUTO DENKO CORPORATION). The cycle characteristics were evaluated in an environment of 25° C. The cycle characteristics were evaluated by repeating a charge/discharge cycle of charging at a constant current and at a constant voltage to 4.2 V at 0.5 C and discharging at a constant current to 2.5 V at 1 C for 50 cycles. The cycle characteristics were evaluated by the discharge capacity retention rate at 50 cycles. The discharge capacity retention rate is the discharge capacity at the 50th cycle when the discharge capacity at the initial (first) cycle is 100%.

After evaluating the cycle characteristics, the lithium ion secondary battery was disassembled and the change in the thickness of the negative electrode was measured. The thickness change rate is obtained by (“thickness of the negative electrode after 50 cycles”−“thickness of the negative electrode before the first charge”)/(“thickness of the negative electrode before the first charge)×100.

### Examples 2 and 3 and Comparative Examples 1 to 3

Examples 2 and 3 and Comparative Examples 1 to 3 are different from Example 1 in that the specific surface area of the surface of the negative electrode active material layer is changed. The specific surface area of the surface of the negative electrode active material layer was adjusted by the strength of sandblasting.

In Example 2, the specific surface area of the negative electrode active material layer was 14.5 m²/g.

In Example 3, the specific surface area of the negative electrode active material layer was 16.0 m²/g.

In Comparative Example 1, the specific surface area of the negative electrode active material layer was 6.5 m²/g.

In Comparative Example 2, the specific surface area of the negative electrode active material layer was 16.1 m²/g.

In Comparative Example 3, the specific surface area of the negative electrode active material layer was 6.9 m²/g.

In Examples 2 and 3 and Comparative Examples 1 to 3, the cycle characteristics and the change in the thickness of the negative electrode were measured in the same manner as that in Example 1. The results are summarized in Table 1.

### Examples 4 to 11

In Examples 4 to 11, the specific surface area of the surface of the negative electrode active material layer was 13.1 m²/g, the thickness of the negative electrode active material layer was fixed at 10.0 μm, and the density of the negative electrode active material layer was changed. Other conditions were the same as those in Example 1. The density of the negative electrode active material layer was changed by adjusting the pressing pressure on the negative electrode slurry after drying.

In Example 4, the density of the negative electrode active material layer was set to 0.30 g/cm³.

In Example 5, the density of the negative electrode active material layer was set to 0.39 g/cm³.

In Example 6, the density of the negative electrode active material layer was set to 0.40 g/cm³.

In Example 7, the density of the negative electrode active material layer was set to 0.70 g/cm³.

In Example 8, the density of the negative electrode active material layer was set to 1.10 g/cm³.

In Example 9, the density of the negative electrode active material layer was set to 1.20 g/cm³.

In Example 10, the density of the negative electrode active material layer was set to 1.40 g/cm³.

In Example 11, the density of the negative electrode active material layer was set to 1.41 g/cm³.

In Examples 4 to 11, the cycle characteristics and the change in the thickness of the negative electrode were measured in the same manner as that in Example 1. The results are summarized in Table 1.

### Examples 12 to 18

In Examples 12 to 18, the specific surface area of the surface of the negative electrode active material layer was 12.4 m²/g, the density of the negative electrode active material layer was fixed at 1.20 g/cm³, and the thickness of the negative electrode active material layer was changed. Other conditions were the same as those in Example 1.

In Example 12, the thickness of the negative electrode active material layer was set to 10.0 μm.

In Example 13, the thickness of the negative electrode active material layer was set to 13.0 pm.

In Example 14, the thickness of the negative electrode active material layer was set to 24.0 μm.

In Example 15, the thickness of the negative electrode active material layer was set to 35.0 μum.

In Example 16, the thickness of the negative electrode active material layer was set to 42.0 μm.

In Example 17, the thickness of the negative electrode active material layer was set to 50.0 μm.

In Example 18, the thickness of the negative electrode active material layer was set to 51.0 μm.

In Examples 12 to 18, the cycle characteristics and the change in the thickness of the negative electrode were measured in the same manner as that in Example 1. The results are summarized in Table 1.

### Examples 19 to 23

In Examples 19 to 23, the specific surface area of the surface of the negative electrode active material layer was fixed at 13.1 m²/g, and then the density of the negative electrode active material layer and the thickness of the negative electrode active material layer were changed. Other conditions were the same as those in Example 1.

In Example 19, the density of the negative electrode active material layer was 0.25 g/cm³, and the thickness of the negative electrode active material layer was 24.0 μm.

In Example 20, the density of the negative electrode active material layer was 1.45 g/cm³, and the thickness of the negative electrode active material layer was 35.0 μm.

In Example 21, the density of the negative electrode active material layer was 1.50 g/cm³, and the thickness of the negative electrode active material layer was 42.0 μm.

In Example 22, the density of the negative electrode active material layer was 1.42 g/cm³, and the thickness of the negative electrode active material layer was 50.0 μm.

In Example 23, the density of the negative electrode active material layer was 1.42 g/cm³, and the thickness of the negative electrode active material layer was 51.0 μm.

In Examples 19 to 23, the cycle characteristics and the change in the thickness of the negative electrode were measured in the same manner as that in Example 1. The results are summarized in Table 1.

### Comparative Examples 4 to 10

In Comparative Examples 4 to 10, the binder used for the negative electrode active material was polyacrylic acid (PAA), and the specific surface area of the surface of the negative electrode active material layer was changed. Other conditions were the same as those in Example 1.

In Comparative Example 4, the specific surface area of the negative electrode active material layer was 6.9 m²/g.

In Comparative Example 5, the specific surface area of the negative electrode active material layer was 7.0 m²/g.

In Comparative Example 6, the specific surface area of the negative electrode active material layer was 11.2 m²/g.

In Comparative Example 7, the specific surface area of the negative electrode active material layer was 12.6 m²/g.

In Comparative Example 8, the specific surface area of the negative electrode active material layer was 14.5 m²/g.

In Comparative Example 9, the specific surface area of the negative electrode active material layer was 16.0 m²/g.

In Comparative Example 10, the specific surface area of the negative electrode active material layer was 16.1 m²/g.

In Comparative Examples 4 to 10, the cycle characteristics and the change in the thickness of the negative electrode were measured in the same manner as that in Example 1. The results are summarized in Table 1.

### Comparative Example 11

In Comparative Example 11, the binder used for the negative electrode active material was changed to styrene-butadiene rubber (SBR) and carboxymethyl cellulose (CMC). Other conditions were the same as those in Example 1.

In Comparative Example 11, the cycle characteristics and the change in the thickness of the negative electrode were measured in the same manner as that in Example 1. The results are summarized in Table 1.

### Comparative Example 12

In Comparative Example 12, the binder used for the negative electrode active material was changed to polyvinyl alcohol (PVA). Other conditions were the same as those in Example 1.

In Comparative Example 12, the cycle characteristics and the change in the thickness of the negative electrode were measured in the same manner as that in Example 1. The results are summarized in Table 1.

TABLE 1

| | Specific | | | | Capacity | Change in |
|---|---|---|---|---|---|---|
| | surface | | | | retention | thickness of |
| | area BET | | Density | Thickness | rate after 50 | electrode |
| | [m²/g] | Binder | [g/cm³] | [μm] | cycles [%] | [%] |
| Example 1 | 7.0 | Copolymer | 1.41 | 9 | 84 | 61 |
| Example 2 | 14.5 | Copolymer | 1.41 | 9 | 84 | 61 |
| Example 3 | 16.0 | Copolymer | 1.41 | 9 | 85 | 60 |
| Comparative | 6.5 | Copolymer | 1.41 | 9 | 71 | 74 |
| Example 1 | | | | | | |
| Comparative | 16.1 | Copolymer | 1.41 | 9 | 70 | 75 |
| Example 2 | | | | | | |
| Comparative | 6.9 | Copolymer | 1.41 | 9 | 72 | 73 |
| Example 3 | | | | | | |
| Example 4 | 13.1 | Copolymer | 0.30 | 10 | 85 | 60 |
| Example 5 | 13.1 | Copolymer | 0.39 | 10 | 82 | 63 |
| Example 6 | 13.1 | Copolymer | 0.40 | 10 | 91 | 55 |
| Example 7 | 13.1 | Copolymer | 0.70 | 10 | 90 | 56 |
| Example 8 | 13.1 | Copolymer | 1.10 | 10 | 92 | 54 |
| Example 9 | 13.1 | Copolymer | 1.20 | 10 | 91 | 55 |
| Example 10 | 13.1 | Copolymer | 1.40 | 10 | 93 | 53 |
| Example 11 | 13.1 | Copolymer | 1.41 | 10 | 81 | 64 |
| Example 12 | 12.4 | Copolymer | 1.20 | 10 | 94 | 52 |
| Example 13 | 12.4 | Copolymer | 1.20 | 13 | 93 | 53 |
| Example 14 | 12.4 | Copolymer | 1.20 | 24 | 95 | 51 |
| Example 15 | 12.4 | Copolymer | 1.20 | 35 | 94 | 52 |
| Example 16 | 12.4 | Copolymer | 1.20 | 42 | 93 | 53 |
| Example 17 | 12.4 | Copolymer | 1.20 | 50 | 92 | 54 |
| Example 18 | 12.4 | Copolymer | 1.20 | 51 | 80 | 65 |
| Example 19 | 13.1 | Copolymer | 0.25 | 24 | 84 | 61 |
| Example 20 | 13.1 | Copolymer | 1.45 | 35 | 85 | 60 |
| Example 21 | 13.1 | Copolymer | 1.50 | 42 | 83 | 62 |
| Example 22 | 13.1 | Copolymer | 1.42 | 50 | 83 | 62 |
| Example 23 | 13.1 | Copolymer | 1.42 | 51 | 81 | 64 |
| Comparative | 6.9 | PAA | 1.41 | 9 | 60 | 84 |
| Example 4 | | | | | | |
| Comparative | 7.0 | PAA | 1.41 | 9 | 70 | 75 |
| Example 5 | | | | | | |
| Comparative | 11.2 | PAA | 1.41 | 9 | 71 | 74 |
| Example 6 | | | | | | |
| Comparative | 12.6 | PAA | 1.41 | 9 | 70 | 75 |
| Example 7 | | | | | | |
| Comparative | 14.5 | PAA | 1.41 | 9 | 71 | 74 |
| Example 8 | | | | | | |
| Comparative | 16.0 | PAA | 1.41 | 9 | 72 | 73 |
| Example 9 | | | | | | |
| Comparative | 16.1 | PAA | 1.41 | 9 | 65 | 79 |
| Example 10 | | | | | | |
| Comparative | 12.5 | SBR/CMC | 1.41 | 9 | 71 | 74 |
| Example 11 | | | | | | |
| Comparative | 12.5 | PVA | 1.41 | 9 | 72 | 73 |
| Example 12 | | | | | | |

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium ion secondary battery

What is claimed is:

1. A negative electrode for a lithium ion secondary battery comprising:
a current collector; and
a negative electrode active material layer which is in contact with at least one surface of the current collector, wherein
the negative electrode active material layer has a negative electrode active material and a binder,
the negative electrode active material contains a material that can be alloyed with Li,
the binder contains a copolymer of a unit represented by following chemical structure (1) and a unit represented by following chemical structure (2), where R is hydrogen or a methyl group and M is an alkali metal element in chemical structure (2), and 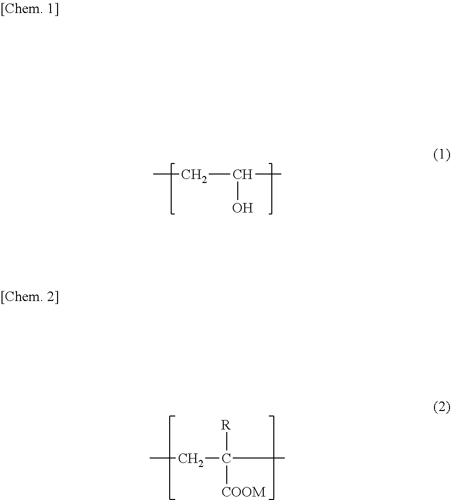
a specific surface area of a surface of the negative electrode active material layer on a side opposite to the current collector side is 7.0 m²/g or more and 16.0 m²/g or less.

2. The negative electrode for a lithium ion secondary battery according to claim 1, wherein
a density of the negative electrode active material layer is 0.4 g/cm³ or more and 1.4 g/cm³ or less.

3. The negative electrode for a lithium ion secondary battery according to claim 1, wherein
the negative electrode active material layer has a thickness of 10 μm or more and 50 μm or less.

4. A lithium ion secondary battery comprising:
the negative electrode for a lithium ion secondary battery according to claim 1.
